(19) United States
(12) Patent Application Publication
(10) Pub. No.: US 2014/0253022 A1
(43) Pub. Date: Sep. 11, 2014

(54) CHARGE CIRCUIT

(71) Applicants: HON HAI PRECISION CO., LTD., New Taipei (TW); HONG FU JIN PRECISION INDUSTRY (ShenZhen) CO., LTD., Shenzhen (CN)

(72) Inventor: HAI-QING ZHOU, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/198,601

(22) Filed: Mar. 6, 2014

(30) Foreign Application Priority Data
Mar. 7, 2013 (CN) 2013100727416

(51) Int. Cl. H02J 7/02; H02J 7/00

(52) U.S. Cl. CPC H02J 7/025; H02J 7/0052
USPC 320/107

(57) ABSTRACT

A charge circuit includes a comparator, first through third electronic switches, first through tenth resistors. A voltage for charging a battery is output to an output of the charge circuit. The output of the charge circuit is grounded through the first and second resistors in that order. A node between the first and second resistors is electrically connected to a non-inverting input terminal of the comparator. An inverting input terminal of the comparator is electrically connected to an anode of the battery. An output terminal of the comparator is electrically connected to the first and third electronic switches. The first electronic switch is electrically connected to the second electronic switch. The second and third electronic switches are selectively turned on according to a voltage of the anode of the battery to change a charging current to the battery.

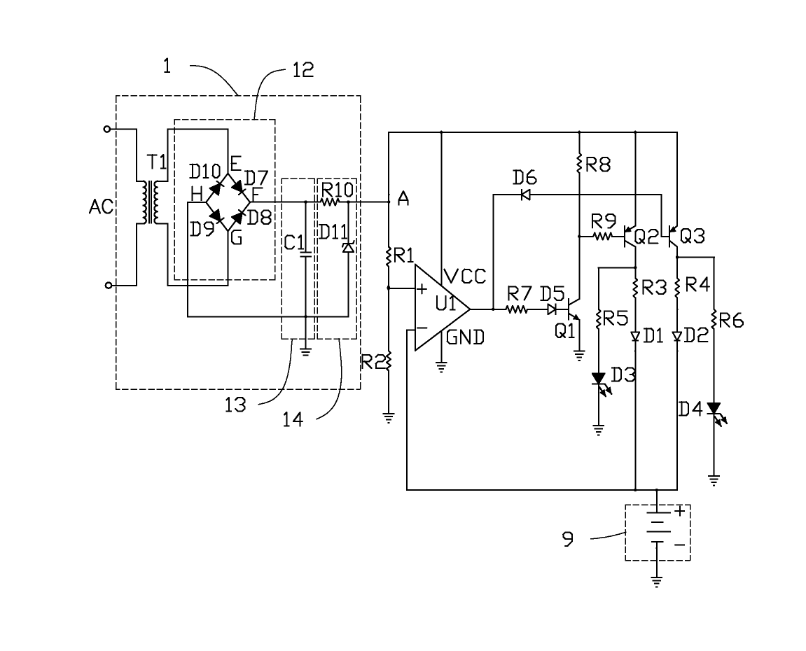

### BACKGROUND

1. Technical Field

The present disclosure relates to a charge circuit.

2. Description of Related Art

The higher the electric current to charge a battery, the shorter the charge time of the battery. However, when a voltage of the battery increases during charging, a high current can damage the battery.

Therefore, there is room for improvement in the art.

### BRIEF DESCRIPTION OF THE DRAWING

Many aspects of the present disclosure can be better understood with reference to the following drawing. The components in the drawing are not necessarily drawn to scale, the emphasis instead being placed upon clearly illustrating the principles of the present disclosure.

The FIGURE is a circuit diagram of an embodiment of a charge circuit of the present disclosure.

### DETAILED DESCRIPTION

The disclosure is illustrated by way of example and not by way of limitation in the figures of the accompanying drawing in which like references indicate similar elements. It should be noted that references to “an” or “one” embodiment in this disclosure are not necessarily to the same embodiment, and such references mean “at least one.” The reference “a plurality of” means “at least two.”

The FIGURE shows an embodiment of a charge circuit of the present disclosure.

The charge circuit is electrically connected between an alternating current (AC) power supply and a battery 9. The charge circuit comprises a converter circuit 1, a comparator U1, Bipolar Junction Transistors (BJTs) Q1-Q3, resistors R1-R9, and light-emitting diodes (LEDs) D3 and D4.

The converter circuit 1 converts AC into direct current (DC) to charge the battery 9. The converter circuit 1 comprises a voltage transformer T1, a bridge rectification circuit 12, a filter circuit 13, and a voltage regulator circuit 14. The voltage transformer T1 is electrically connected between the AC power supply and the bridge rectification circuit 12. The bridge rectification circuit 12 comprises four diodes D7-D10. An anode of the diode D7 is electrically connected to a cathode of the diode D10. A cathode of the diode D7 is electrically connected to a cathode of the diode D8. An anode of the diode D8 is electrically connected to a cathode of the diode D9. An anode of the diode D9 is electrically connected to an anode of the diode D10. A node E between the anode of the diode D7 and the cathode of the diode D10 is electrically connected to a first output terminal of the voltage transformer T1. A node G between the anode of the diode D8 and the cathode of the diode D9 is electrically connected to a second output terminal of the voltage transformer T1.

The filter circuit 13 comprises a capacitor C1. A first terminal of the capacitor C1 is grounded. A second terminal of the capacitor C1 is electrically connected to a node F between the cathode of the diode D7 and the cathode of the diode D8. The voltage regulator circuit 14 comprises a resistor R10 and a diode D11. An anode of the diode D11 is grounded. A cathode of the diode D11 is electrically connected to the node F through the resistor R10. A node A between the cathode of the diode D11 and the resistor R10 serves as an output of the converter circuit 1.

The output of the converter circuit 1 is grounded through the resistors R1 and R2 in that order. A node between the resistors R1 and R2 is electrically connected to a non-inverting input terminal of the comparator U1. An inverting input terminal of the comparator U1 is electrically connected to an anode of the battery 9. A power terminal of the comparator U1 is electrically connected to the output of the converter circuit 1. A ground terminal of the comparator U1 is grounded. An output terminal of the comparator U1 is electrically connected to an anode of the diode D5 through the resistor R7. A cathode of the diode D5 is electrically connected to a base of the BJT Q1. A collector of the BJT Q1 is electrically connected to the output of the converter circuit 1 through the resistor R8. An emitter of the BJT Q1 is grounded. The collector of the BJT Q1 is electrically connected to a base of the BJT Q2 through the resistor R9. An emitter of the BJT Q2 is electrically connected to the output of the converter circuit 1. A collector of the BJT Q2 is electrically connected to an anode of the diode D1 through the resistor R3. A cathode of the diode D1 is electrically connected to the anode of the battery 9. The collector of the BJT Q2 is electrically connected to an anode of the LED D3 through the resistor R5. A cathode of the LED D3 is grounded.

The output terminal of the comparator U1 is electrically connected to a cathode of the diode D6. An anode of the diode D6 is electrically connected to a base of the BJT Q3. An emitter of the BJT Q3 is electrically connected to the output of the converter circuit 1. A collector of the BJT Q3 is electrically connected to the anode of the diode D2 through the resistor R4. A cathode of the diode D2 is electrically connected to the anode of the battery 9. The collector of the BJT Q3 is electrically connected to an anode of the LED D4 through the resistor R6. A cathode of the LED D4 is grounded. A cathode of the battery 9 is grounded.

In the embodiment, the BJT Q1 is an NPN BJT. The BJTs Q2 and Q3 are PNP BJTs. In other embodiments, the BJTs Q1-Q3 can be replaced by other suitable electronic switches.

A resistance of the resistor R3 is smaller than a resistance of the resistor R4. The converter circuit 1 converts AC into DC and outputs a first voltage at the node A. The first voltage is divided between the resistors R1 and R2. A second voltage at the node between the resistors R1 and R2 is obtained from the divided first voltage. The second voltage is output to the non-inverting input terminal of the comparator U1. When the battery 9 is charging, a third voltage of the anode of the battery 9 increases. When the third voltage is smaller than the second voltage, the comparator U1 outputs a high-level signal, such as logic 1. When the base of the BJT Q1 receives the high-level signal, the collector of the BJT Q1 is electrically connected to the emitter of the BJT Q1, the base of the BJT Q2 is grounded, the collector of the BJT Q2 is electrically connected to the emitter of the BJT Q2, the base of the BJT Q3 is electrically connected to the anode of the diode D6, and the BJT Q3 is turned off. Thus, the battery 9 gets charged from the output of the converter circuit 1 through the resistor R3, and the LED D3 is lit up. When the third voltage is greater than the second voltage, the comparator U1 outputs a low-level signal, such as logic 0. When the base of the BJT Q1 receives the low-level signal, the collector of the BJT Q1 is electrically disconnected from the emitter of the BJT Q1, the BJT Q1 is turned off, the BJT Q2 is turned off, the diode D6 is turned on, and the BJT Q3 is turned on. Thus, the battery 9 gets charged from the output of the converter circuit 1 through the resistor R4, and the LED D4 is lit up. When the third voltage is lower than the second voltage, the BJT Q2 is turned on, and the first voltage charges the battery 9 through the resistor R3, thus charging the battery 9 quickly. When the third voltage is higher than the second voltage, the BJT Q3 is turned on, and the first voltage charges the battery 9 through the resistor R4, thus providing a lower charging current to the battery 9 and preventing damage to the battery.

While the disclosure has been described by way of example and in terms of preferred embodiment, it is to be understood that the disclosure is not limited thereto. To the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A charge circuit, comprising: a comparator, first to third electronic switches, and first to fourth resistors, wherein a voltage for charging a battery is output from an output of the charge circuit, the output of the charge circuit is grounded through the first and second resistors in that order, a node between the first and second resistors are connected to a non-inverting input terminal of the comparator, an inverting input terminal of the comparator is connected to an anode of the battery, an output terminal of the comparator is connected to control terminals of the first and third electronic switches, a first terminal of the first electronic switch is connected to the output of the charge circuit and the control terminal of the second electronic switch, a second terminal of the first electronic switch is grounded, a first terminal of the second electronic switch is connected to the output of the charge circuit, a second terminal of the second electronic switch is connected to the anode of the battery through the third resistor, a first terminal of the third electronic switch is connected to the output of the charge circuit, a second terminal of the third electronic switch is connected to the anode of the battery through the fourth resistor, a cathode of the battery is grounded, a resistance of the third resistor is smaller than the fourth resistor, when the control terminal of the first electronic switch receives a high level signal, the first terminal of the first electronic switch is connected to the second terminal of the first electronic switch, when the control terminal of the first electronic switch receives a low level signal ,the first terminal of the first electronic switch is disconnected from the second terminal of the first electronic switch, when the control terminal of the second electronic switch receives a high level signal, the first terminal of the second electronic switch is disconnected from the second terminal of the second electronic switch, when the control terminal of the second electronic switch receives a low level signal, the first terminal of the second electronic switch is connected to the second terminal of the second electronic switch, when the control terminal of the third electronic switch receives a high level signal, the first terminal of the third electronic switch is disconnected from the second terminal of the third electronic switch, when the control terminal of the third electronic switch receives a low level signal, the first terminal of the third electronic switch is connected to the second terminal of the third electronic switch, the output terminal of the comparator is connected to the control terminal of the third electronic switch through a first diode, an anode of the first diode is connected to the control terminal of the third electronic switch, and a cathode of the first diode is connected to the output terminal of the comparator.

2. The charge circuit of claim 1, further comprising a converter circuit connected between an alternating current (AC) power supply and the output of the charge circuit, for converting AC of the AC power supply into direct current (DC).

3. The charge circuit of claim 1, wherein the output terminal of the comparator is connected to an anode of a second diode through a fifth resistor, and a cathode of the second diode is connected to the control terminal of the first electronic switch.

4. The charge circuit of claim 1, wherein the first terminal of the first electronic switch is connected to the output of the charge circuit through a sixth resistor.

5. The charge circuit of claim 1, wherein the first terminal of the first electronic switch is connected to the control terminal of the second electronic switch through a seventh resistor.

6. The charge circuit of claim 1, wherein the third resistor is connected to the anode of the battery through a third diode, an anode of the third diode is connected to the third resistor, and a cathode of the third diode is connected to the anode of the battery.

7. The charge circuit of claim 1, wherein the fourth resistor is connected to the anode of the battery through a fourth diode, an anode of the fourth diode is connected to the fourth resistor, and a cathode of the fourth diode is connected to the anode of the battery.

8. The charge circuit of claim 1, wherein the second terminal of the second electronic switch is connected to an anode of a first light-emitting diode (LED) through an eighth resistor, and a cathode of the first LED is grounded.

9. The charge circuit of claim 8, wherein the second terminal of the third electronic switch is connected an anode of a second LED through a ninth resistor, and a cathode of the second LED is grounded.
